(19) United States
(12) Patent Application Publication
(10) Pub. No.: US 2020/0059025 A1
(43) Pub. Date: Feb. 20, 2020

(54) CONNECTOR

(71) Applicant: TECHNETIX B.V., Veenendaal (NL)

(72) Inventors: David MARTIN, West Sussex (GB); Paul CHAPMAN, West Sussex (GB)

(21) Appl. No.: 16/544,261

(22) Filed: Aug. 19, 2019

(30) Foreign Application Priority Data
Aug. 20, 2018 (GB) 1813523.6

(51) Int. Cl. H01R 13/11

(52) U.S. Cl. CPC H01R 13/111

(57) ABSTRACT

A connector comprising a body within which is located a tubular member for receiving and electrically contacting a pin of a male-type, wherein the tubular member comprises a first gripping section comprising a first crimped region and at least one aperture disposed proximal the crimped region. The gripping section is elastically deformable and the connector is able to be used repeatedly to receive male-pins of different diameters.

### FIELD OF THE INVENTION

This invention relates to connectors used to establish an electrical connection, and in s particular female connectors as used in telecommunication and electrical networks.

### BACKGROUND TO THE INVENTION

Female connectors are generally provided with a central conductor socket to receive a male centre pin. The sockets are manufactured as wrapped pressed metal components from metal sheet with the open insertion end of the socket formed as fingers to grip the male pin when it is inserted. Sometimes spring clips or elastic sleeves can be positioned over the fingers to improve grip.

In situations where the male pin is withdrawn and reinserted on a number of occasions, the is grip of the female socket on the male pin tends to loosen, breaking the electrical connection between the pin and socket.

### SUMMARY OF THE INVENTION

In accordance with the present invention, there is provided a connector comprising a body within which is located a tubular member for receiving and electrically contacting a pin of a male-type, wherein the tubular member comprises a first gripping section comprising a first crimped region and at least one aperture disposed proximal the crimped region. Such a connector is able to receive male-type pins having different diameters as the gripping section is expandable to accommodate larger diameter pins. The crimped region has a reduced diameter which correlates to the minimum diameter of a male pin that the connector is required to connect to.

The tubular member preferably further comprises a second gripping section comprising a second crimped region and at least one aperture disposed proximal the second crimped region, the first and second gripping sections being spaced apart and each positioned proximal one end of the tubular member. Thus the connector is able to receive two male-type pins from opposing ends of the tubular member and each gripping section is expandable to accommodate larger diameter pins.

Instead of providing two gripping sections, the tubular member may further comprise a crimped section spaced apart from the first gripping section and capable of receiving a pin of a male-type. The crimped section receives male-type pins of a set diameter determined by s the diameter of the crimped section and is not able to accommodate pins of a different diameter.

Preferably the or each gripping section is elastically deformable, expanding from a smaller diameter to a larger diameter on insertion of a male pin with a larger diameter and restoring to the first diameter on removal of the male pin. By having a gripping section that exhibits elastic behaviour, the connector is able to be used multiple times with pins having different diameters without electrical contact between the connector and pin being compromised.

A plurality of apertures may be provided proximal the or each crimped region, and of particular preference at least three apertures are circumferentially spaced around the tubular member proximal the or each crimped region.

The at least one or each aperture may be ovoid in shape. Alternatively the at least one or each aperture may comprise a substantially elongate slot extending longitudinally along the tubular member.

Where the aperture is ovoid, preferably one or more apertures are provided on opposing sides of the or each crimped region, there thus being at least one aperture on each side of the or each crimped region, and preferably three apertures on each side of the crimped region. Typically the three apertures will be circumferentially equispaced.

The tubular member is preferably formed as a seamless tube and is preferably formed from metal.

The invention will now be described, by way of example, with reference to the accompanying drawings in which:

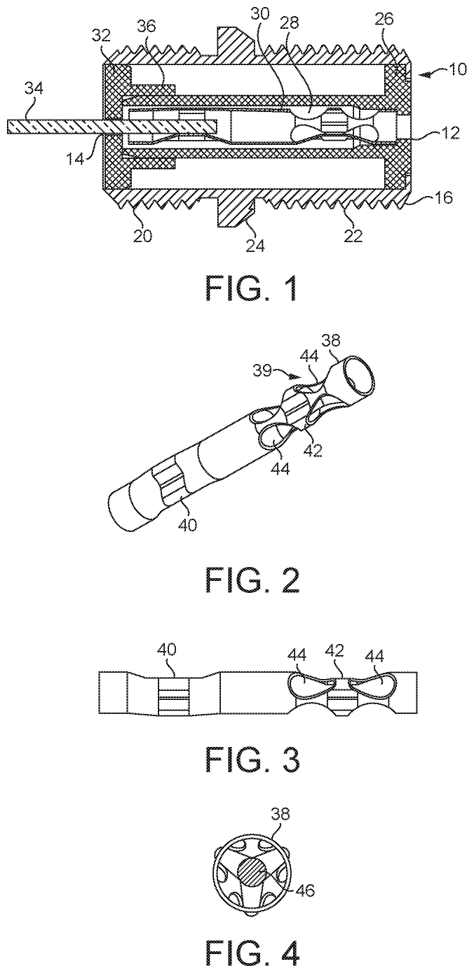

FIG. 1 shows a section through one embodiment of a connector;

FIG. 2 shows a perspective view of a tubular socket within the connector;

FIG. 3 shows a side view of the tubular socket;

FIG. 4 shows an end view of the tubular socket;

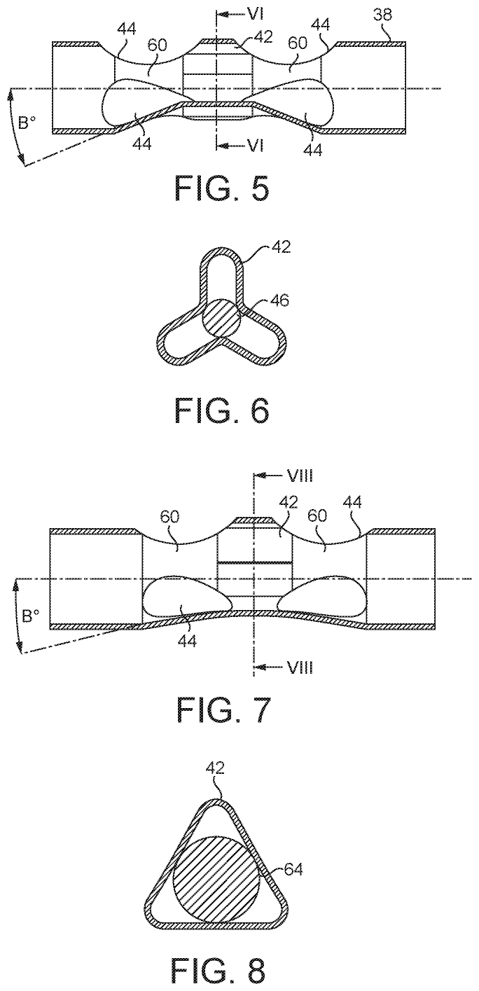

FIG. 5 shows a cross-section through part of the tubular socket;

FIG. 6 shows a section along line VI of FIG. 5;

FIG. 7 shows a cross-section through part of the tubular socket during expansion;

FIG. 8 shows a section along line VIII of FIG. 7;

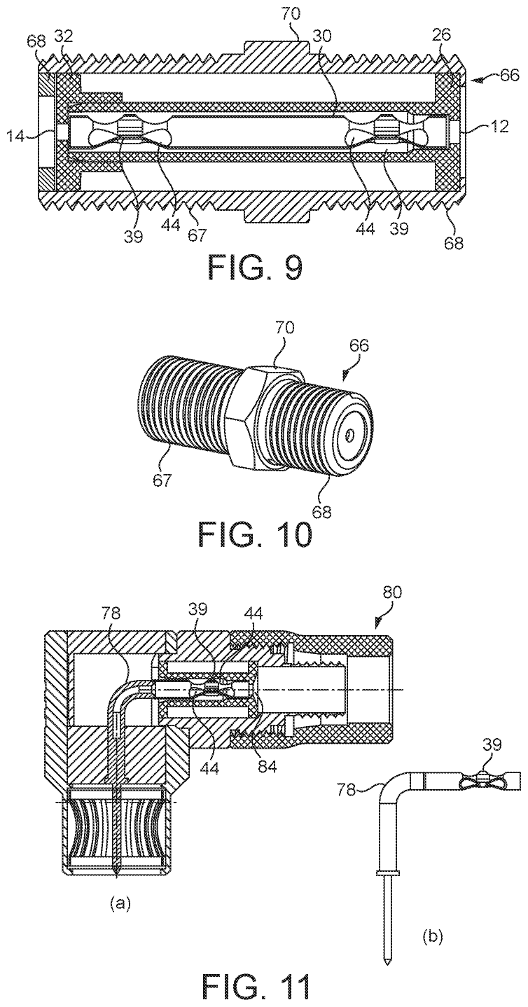

FIG. 9 shows a section through a second embodiment of a connector;

FIG. 10 shows a perspective view of the connector of FIG. 9;

FIG. 11(a) shows a section through a third embodiment of a connector where a male pin is attached to one end of the tubular socket with FIG. 11(b) showing a detailed side view of the tubular socket;

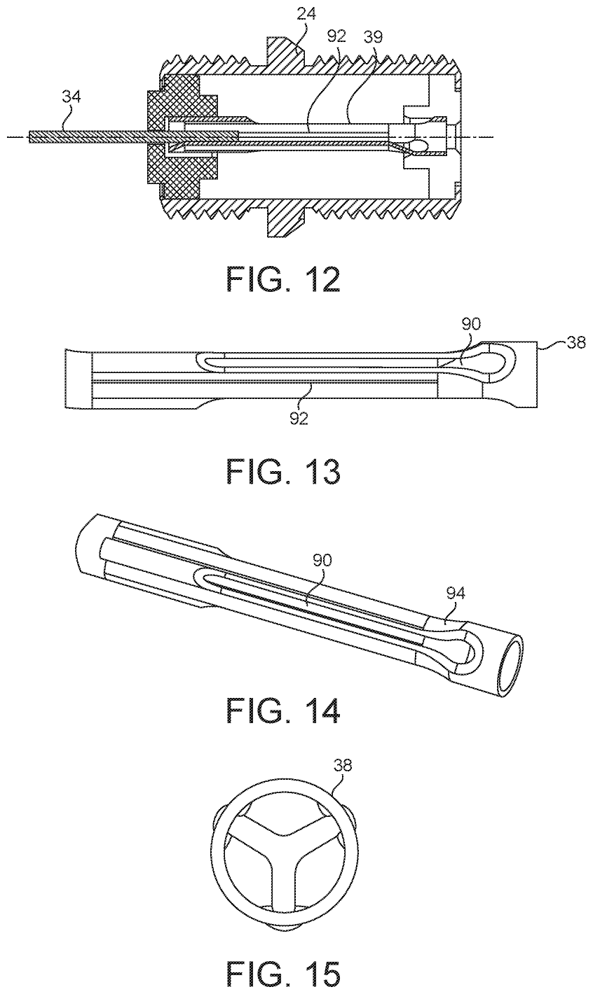

FIG. 12 shows a section through a fourth embodiment of a connector;

FIG. 13 shows a side view of an alternative form of the tubular socket;

FIG. 14 shows a perspective view of the tubular socket shown in FIG. 13; and

FIG. 15 shows an end view of the tubular socket shown in FIG. 13.

### DESCRIPTION

FIG. 1 shows a centre connector 10 capable of receiving male pins at front and rear openings 12 and 14. Connector 10 is substantially cylindrical with tubular connector body 16 having two externally threaded sections 20, 22 separated by a hexagonal circumferential lip 24. Plastics housing 26 is located within body 16 and has a central channel 28 associated with front opening 12 and within which connector socket 30 is disposed. At the rear of body 16, plastics collar 32 is also located within body 16, collar 32 having central opening 14 for receiving a male pin 34 and a neck portion 36 for receiving housing 26, typically by way of a push-fit connection. Collar 32 and housing 26 are typically secured within body 16 by a push-fit connection.

Connector socket 30 is formed from a seamless metal tube 38 which can be seen in more detail in FIGS. 2, 3 and 4. Tube 38 has one gripping section 39 and a crimped section 40 which are capable of gripping a male pin inserted respectively through inlet 12 and inlet 14. Gripping section 39 can accept a range of male centre pin diameters, whereas crimped section 40 is configured to fit a single diameter of male connector pin. Gripping section 39 is formed with a crimped region 42 associated with apertures 44, whereas crimped section 40 is formed as only a crimped region. The diameter of tube 38 is reduced where crimping has occurred.

To allow front gripping section 39 to repeatedly accept and connect to male centre pins s having different diameters, ovoid-shaped or scallop-shaped apertures 44 are formed each side of crimped region 42, with typically three circumferentially equispaced apertures 44 provided each side of crimped region 42, see FIGS. 2 and 3. As can be seen in the cross-section shown in FIG. 4, gripping section 39 has a central region 46 that will accept a male pin of the same diameter as region 46.

FIGS. 5 to 8 illustrate how gripping section 39 expands to accept male pins of different diameters. FIGS. 5 and 6 show connector tube 38 in its rest position with crimped region 42 at its minimum diameter and which produces a star form cross-section as shown in FIG. 6. Pins having a diameter the same as that of region 46, typically of 0.6 mm diameter, can be inserted into tube 38 to establish electrical contact without gripping region 39 deflecting from the initial rest position. Angle B represents the angle of the side walls of tube 38 in relation to the central axis in the region where apertures 44 are positioned adjacent crimped region 42. As a male pin having a diameter larger than region 46 is pushed into socket 30 through entrance 14, bridge portions 60 between scalloped cut-outs 44 deflect, as shown in FIG. 7 where Angle B has reduced. This causes crimped region 42 to expand and open from the star form shown in FIG. 6 to increase its diameter, see FIG. 7, so to be able to accommodate pins of the same diameter as region 64 as shown in FIG. 8. The expansion of crimped region 42 and the diameter of region 64 will depend on the diameter pin inserted but will have a maximum diameter of around 1.3 mm

Gripping section 39 is elastic and when a male pin is retracted, it will restore to the original diameter as shown in FIGS. 5 and 6. This allows the connector to be repeatedly reused for male pins of different diameters.

The strength and elasticity of the grip exerted by gripping section 39 can be modified by the crimp length and aperture size selected together with appropriate selection of metals, metal thickness and metal treatment steps.

FIG. 9 shows a second embodiment of a connector 66 where two gripping sections 39 with ovoid apertures 44 are used so that each input 12, 14 can accommodate male pins of different diameters. End plug 68 is also shown. FIG. 10 shows a perspective view of connector 66 of FIG. 9, with externally threaded sections 67, 68 separated by hexagonal lip 70.

A connector socket with an elastic grip section can be provided in any type of connector required to receive a male pin and a third embodiment is shown in FIGS. 11(a) and (b) where a single gripping section 39 with ovoid apertures 44 is combined with a male centre pin 78 in a right-angle connector 80, gripping section 39 able to receive male pins of different diameters that are inserted through opening 84.

A further embodiment is shown in FIG. 12 where front gripping section 39 incorporates elongate apertures or slots 90, with typically three slots 90 being circumferentially equispaced around tubular socket 38, see FIGS. 13 to 15. The slots 90 extend partway along the length of tube 38, with crimped regions 92 positioned between the slots. As with the embodiment shown in FIG. 1, insertion of a male pin of diameter larger than the reduced diameter of gripping section 39 causes the non-cutaway portions 94 to deflect and so extend crimped regions 92. Removal of a male pin will cause the crimped regions to restore to their initial positions. Altering the length and width of slots 90 will modify the gripping force exerted by section 39.

The connectors described are capable of accepting a range of male centre pin diameters, typically ranging from 0.64 mm to 1.3 mm, whilst maintaining a minimum 115 g withdrawal force after repeated insertions of largest and smallest diameter male pins. The crimped seamless tube with the apertures associated with the crimped regions provides a component with good hoop strength at both ends and the ability to accommodate different diameter male pins after repeated insertions of the largest and smallest diameter male pins without the need for any additional spring or support components or soldering.

1. A connector comprising a body within which is located a tubular member for receiving and electrically contacting a pin of a male-type, wherein the tubular member comprises a first gripping section comprising a first crimped region and at least one aperture disposed s proximal the crimped region.

2. A connector according to claim 1, wherein the tubular member further comprises a second gripping section comprising a second crimped region and at least one aperture disposed proximal the second crimped region, the first and second gripping sections being spaced apart and each positioned proximal one end of the tubular member.

3. A connector according to claim 1, wherein the tubular member further comprises a crimped section spaced apart from the first gripping section and capable of receiving a pin of a male-type.

4. A connector according to claim 1, wherein the gripping section is elastically deformable.

5. A connector according to claim 1, wherein a plurality of apertures are provided proximal the crimped region.

6. A connector according to claim 5, wherein at least three apertures are circumferentially spaced around the tubular member proximal the crimped region.

7. A connector according to claim 1, wherein the at least one aperture is ovoid in shape.

8. A connector according to claim 7, wherein one or more apertures are provided on opposing sides of the crimped region.

9. A connector according to claim 8, wherein three apertures are disposed on each side of the crimped region.

10. A connector according to claim 1, wherein the at least one aperture comprises a substantially elongate slot extending longitudinally along the tubular member.

11. A connector according to claim 1, wherein the tubular member is formed as a seamless tube.

12. A connector according to claim 1, wherein the tubular member is formed from metal.
